(19) United States
(12) Patent Application Publication
(10) Pub. No.: US 2005/0140065 A1
(43) Pub. Date: Jun. 30, 2005

(54) Method and device for connecting molded parts

(76) Inventors: Hans-Martin Sauer, Darmstadt (DE); Sohaib Elgimiabi, Dreleich (DE); Stefan Spiekermann, Darmstadt (DE); Rolf Hempelmann, St. Ingbert (DE); Horst Groeger, Kirchheim (DE)

Correspondence Address: HENKEL CORPORATION, THE TRIAD, SUITE 200, 2200 RENAISSANCE BLVD., GULPH MILLS, PA, 19406, US

(21) Appl. No.: 10/996,928

(22) Filed: Nov. 24, 2004

Related U.S. Application Data
(63) Continuation of application No. PCT/EP03/05251, filed on May 19, 2003.

(30) Foreign Application Priority Data
May 25, 2002 (DE) 102 23 341.1
May 15, 2003 (DE) 103 22 055.0

(51) Int. Cl. B29C 35/08

(52) U.S. Cl. 264/489; 425/174.4

(57) ABSTRACT

Molded parts are connected by means of an adhesive seam containing an adhesive capable of being hardened by heat. The molded parts (at least one of which is non-metallic) are inserted between a plurality of metal molds, with at least one metal mold having a groove along the region of the adhesive seam. The adhesive seam is applied, the metal molds and the molded parts are compressed, and the adhesive seam is heated by means of microwave energy from a microwave line contained in the groove of the metal mold.

### CROSS-REFERENCE TO RELATED APPLICATIONS

This application is a continuation under 35 USC Sections 365(c) and 120 of International Application No. PCT/EP03/05251, filed 19 May 2003 and published 4 Dec. 2003 as WO 03/099542, which claims priority from German Application No. 10223341.1, filed 25 May 2002, and German Application No. 10322055.0, filed 15 May 2003, each of which is incorporated herein by reference in its entirety.

### FIELD OF THE INVENTION

The invention relates to a method for connecting molded parts, at least one of which consists of non-metallic material, by means of at least one adhesive seam consisting of an adhesive that can be hardened by heat, the molded parts being respectively placed, at least in certain regions, into a metal mold, at least one of which molds is provided with a groove along the adhesive seam, and the adhesive seam is applied, after which the metal molds and the molded parts are pressed together and the adhesive seam is heated.

The invention also relates to a device for connecting molded parts by means of an adhesive seam consisting of an adhesive that can be hardened by heat, at least one molded part consisting of non-metallic material, with two metal molds, into which the respective molded part can be placed, at least in certain regions, at least one metal mold being provided with a groove along the adhesive seam.

### DISCUSSION OF THE RELATED ART

It is known, for example in automobile or aircraft construction, to create components which comprise at least two molded parts which are adhesively bonded to one another. To obtain components with the greatest possible precision, metal pressing molds are used for this purpose, the molded parts that are to be connected being placed into the pressing mold parts thereof, the molded parts that are to be connected having previously been provided with an adhesive seam which is arranged in such a way that it is arranged inside the metal pressing mold parallel to grooves, preferably milled grooves, generally formed on both sides of the molded parts in the pressing mold parts. Adhesive seams which consist of an adhesive that can be hardened by heat, for example polyurethane adhesive, are used for this. After placing the molded parts into the pressing mold, the pressing mold is closed, the parts are pressed together and the adhesive seam is heated, in order that the adhesive can harden or fully polymerize. The necessary heat can be introduced for example through the grooves by means of hot fluids, for example hot air. However, these grooves primarily serve for supplying and removing coolants, air, water, hydraulic oils and exhaust gases. The introduction of heated fluids is laborious and the heating of the adhesive layer that can be achieved in this way takes place very slowly, since the heat has to be brought into the adhesive seam through the molded parts to be joined, i.e. the thermal energy reaches the intended destination exclusively by heat conduction. Since, however, plastic parts with low thermal conductivity are increasingly replacing the currently still customary metal sheets with high thermal conductivity, a correspondingly great amount of time has to be expended on performing such adhesive bonding, which leads to correspondingly long cycle times in automobile construction. A further disadvantage with this type of heating is that very massive aluminum castings are required for the metal pressing mold in order to maintain the required close dimensional tolerances of the molded parts in spite of the cyclical heating and cooling of the adhesive bonding installation. Furthermore, conversion of such an installation for a change of model is expensive and time-consuming, or in some cases may even not be possible at all.

In principle it is known, for the heating of polymers for example, to use microwaves (for example WO 01/30118 A1 or WO 01/28771 A1). Microwaves are also used for heating adhesives (DE 100 40 325 A); if appropriate, the adhesives are in this case provided with ferromagnetic nanoparticles (DE 100 37 883 A1) or magnetic nanoparticles (DE 199 54 960 A1). In this case, depending on the nature of the adhesives, it may also be additionally provided that they are exposed to a DC magnetic field. These known microwave adhesive-bonding methods are not suitable however for methods of the generic type for connecting molded parts between metal molds.

### BRIEF SUMMARY OF THE INVENTION

The object of the invention is therefore to provide a solution by which the necessary heating of the adhesive seam between two molded parts arranged between two metal molds can be carried out in the shortest time possible in order to speed up the course of the method.

According to the invention, this object is achieved with a method of the type specified at the beginning by a microwave line being inserted into the groove of one of the metal molds and, once the metal molds and the molded parts have been pressed together, introducing microwaves into the groove by means of the microwave line in order to heat the adhesive seam absorbing the microwaves.

With this method it is possible in a very short time to heat the adhesive seam between molded parts which are completely or largely enclosed by two metal molds, for example two pressing mold parts of a metal pressing mold, during the adhesive bonding, in order to permit the hardening of the adhesive in a short time, so that the cycle times are significantly reduced. This is made possible by the microwave line being integrated in the groove of one of the metal molds, so that the microwaves can therefore radiate through the metal molds to the adhesive seam as it were from the inside, unhindered by the outer shielding. Since neither the molded parts themselves nor the metal molds have to be heated, the metal molds can be designed to be of a substantially lighter type of construction than pressing mold parts of metal pressing molds consisting of massive aluminum castings. No mechanical deformations, or only slight deformations, occur during the hardening of the adhesive. As a result, the method offers the possibility of using metal pressing molds of a simpler type of construction or dispensing with them entirely and using two metal molds which are separate from each other and can be brought together with the aid of handling devices or the like.

### BRIEF DESCRIPTION OF THE DRAWINGS

FIG. 1 shows a cross section through a first embodiment of a device according to the invention.

FIG. 2 shows a longitudinal section through the device according to FIG. 1.

FIG. 3 shows a perspective representation of a second embodiment of a device according to the invention.

FIG. 4 shows a perspective representation of a third embodiment of a device according to the invention.

### DETAILED DESCRIPTION OF CERTAIN EMBODIMENTS OF THE INVENTION

According to a first preferred configuration, it is provided that a hollow conductor is used as the microwave line. Since the groove in the at least one metal mold can be made with greater dimensions than in the case of conventional metal pressing molds, more space is available for the microwave supply lines, so that customary hollow conductors can also be used as the microwave line.

This aforementioned configuration is expedient in particular whenever it is provided, in a most preferred configuration, that the molded parts are gripped by the respective metal mold arranged on a handling device, at least one molded part is moved along an adhesive discharge and after that the two metal molds with the molded parts are pressed together. The method can then be carried out without a metal pressing mold, it being possible instead to use two metal molds which are formed in the manner of a master, in the case of which one of the upper sides is formed in a block of for example lightweight material (aluminum honeycomb structures, aluminum foam and rigid plastic foam) in such a way that it can receive in a form-fitting manner one of the two molded parts, on the side opposite from the adhesive seam. In this case, additional channels which can receive the microwave line (hollow conductor or coaxial conductor) are milled out along the later adhesive seam. During the adhesive bonding of the molded parts, it is then possible to use for example conventional industrial robots, which carry the two metal molds on their arms and use these tools to receive the two molded parts to be joined. One of the two molded parts, for example, the inner shell of a motor vehicle door, is moved along the later adhesive seam at a stationarily mounted metering nozzle of an adhesive dispenser. The metering nozzle squirts a bead of adhesive, for example, onto the later adhesive seam. After that, the robots with the two metal molds put together the two molded parts (for example the inner shell and outer shell of the door) and the microwave energy source is switched on. The adhesive then begins to heat up and harden. Once the hardening time has elapsed, the microwave device is switched off. A robot arm or the metal mold fastened to it is decoupled from the connected molded parts. The other robot arm then puts down the finished part. A next adhesive cycle can begin. If different molded parts are to be adhesively bonded in alternation, the respective robot can put down the metal molds and pick up differently designed metal molds. It is evident that this simple procedure is not possible in the case of metal pressing molds.

Alternatively, it may also be provided that a coaxial conductor, which is formed by a wire-like or tubular insulated inner conductor which is inserted into the groove and by the groove edge region of the metal mold, is used as the microwave line. This configuration is suitable in particular, but not exclusively, for carrying out the method in a metal pressing mold. In this case, the groove edge region serves as an outer line of the microwave line, in that an insulated wire or tubular inner conductor, which like the groove edge region is connected to the microwave energy source, is inserted into the groove. Metal pressing molds for fixing parts of plastic or metal sheet are generally produced from diecast aluminum and have along the entire adhesive seam a milled groove which is a few cm deep and wide (for example 3 cm deep and 2 cm wide).

An insulated metal wire or an insulated metal tube, which can guide microwaves through the milled groove on the principle of a coaxial conductor, is inserted into this groove. This form of the method can always be used whenever at least one of the two molded parts to be joined does not consist of metal sheet. The second part of the coaxial conductor, that is to say the outer conductor, is formed by the groove edge region. The groove itself is not completely filled by the inner conductor, so that it is additionally suitable for supplying fluids, for example, for supplying and removing coolants or the like.

If one molded part contains metal, it may additionally be used as the outer conductor of the coaxial conductor, this molded part then being arranged between the metal molds opposite the other molded part consisting of non-metallic material (preferably of plastic), on the side facing away from the groove receiving the inner conductor. The method is therefore also suitable whenever the two molded parts to be joined do not both consist of non-metallic material. A precondition however is that at least one molded part consists of a non-metallic material.

Since the groove is not completely filled with the inner conductor, it is provided in a preferred configuration that fluid is introduced, for example for cooling purposes, through the tubular inner conductor, i.e., if it is of a tubular configuration, and/or the groove. An introduced gas can serve at the same time as an insulating medium. At end points at which gas or liquids are introduced into the groove, additional insulating measures which prevent microwave energy from escaping to the outside must be provided.

If very long milled grooves or very large microwave outputs are to be used, it is preferably provided that a number of microwave conductor portions which are separately supplied with microwave energy are inserted over the length of the groove.

The method may also be used whenever, as described for example in DE 100 37 883 A1, resonance-optimized ferrites or, as described in DE 199 54 960 A1, microscalar and nanoscalar ferrite powders are incorporated as microwave absorbers in the plastic or the parts to be joined. In this case, it is preferably provided that a DC field is additionally applied to the adhesive seam during the pressing operation. For this purpose, permanent magnets may preferably be inserted into the groove not receiving the inner conductor, the magnetic field of said magnets penetrating through the molded part facing away from the microwave line (for example a metal sheet 0.25 to 2 mm thick), into the plastic mixed with nanoferrites. While the magnetic lines of flux of the permanent magnet point in a predominantly radial direction with respect to the inner microwave conductor of the coaxial structure, the magnetic lines of flux of the microwave field enclose the inner conductor and consequently run in a circular manner, i.e. perpendicularly in relation to the DC field. This corresponds exactly to the requirements specified in DE 100 37 883 A1 for the microwave polarization, according to which the angle between two fields is preferably to lie between 45° and 145°.

In a preferred configuration, it is provided that the adhesive seam absorbing microwaves contains microwave-absorbing fillers, in particular carbon black, ferrites, metal particles, expanded metal and/or dielectrically absorbing salts, preferably barium titanate. If ferrites are used as fillers, their proportion by weight of the adhesive preferably lies between 0.2 and 5% by weight, in particular between 0.5 and 3.0% by weight. The following come into consideration with preference as ferrites:
Me^{a}₁₋ₓMe^{b}ₓFe₂O₄ or Li₁₋ₓZn₂ₓFe₅₋ₓO₈ where
Me^{a}=Mn, Co, Ni, Mg, Ca, Cu, Zn, Y, V and/or Co;
Me^{b}=Zn and/or Cd, and
X=0-1, in particular 0.05-0.95.

M^{a} and M^{b} stand for a bivalent metal component, it being possible in each case that only one of the metal ions enumerated is added, or else more than one of the metal ions enumerated are added. The stoichiometry of the individual metals is chosen such that the ferrites are electrically neutral. Superparamagnetic nanoscalar particles of a ferrite with a volume-averaged particle diameter in the range from 2 to 100 nm are preferably used.

According to a particularly preferred embodiment, ferrites of the general formula M^{a}₁₋ₓM^{b}ₓFe₂O₄ or Li_{1-xZn}₂ₓFe₅₋ₓO₈ are selected, X being at least 0.2, in particular for M^{a}₁₋ₓM^{b}ₓFe₂O₄. Particularly preferred furthermore are ferrites of the general formula M^{a}₁₋ₓZnxFe₂O₄ with X=0-1, in particular at least 0.2 and preferably 0.2 to 0.8, in particular 0.3 to 0.5.

According to a further particularly preferred embodiment, ferrites of the general formula Mn₁₋ₓM^{b}ₓFe₂O₄ are used, M^{b} being selected from Zn and Cd, in particular Zn, and X=0.2-0.5, in particular 0.3-0.4.

According to a further particularly preferred embodiment, ferrites of the general formula Co₁₋ₓM^{b}ₓFe₂O₄ are used, M^{b} being selected from Zn and Cd, in particular Zn, and X=0.2-0.8, in particular 0.4-0.6.

According to a further particularly preferred embodiment, ferrites of the general formula Ni₁₋ₓM^{b}ₓFe₂O₄ are used, M^{b} being selected from Zn and Cd, in particular Zn, and X=0.3-0.8, in particular 0.5-0.6.

Particularly preferred furthermore are embodiments which contain lithium zinc ferrites of the general formula Li₁₋ₓZn₂ₓFe₅₋ₓO₈ with X=0-1, in particular at least 0.1.

According to a further particularly preferred embodiment, LiFe₅O₈ is contained.

For the purposes of the present application, “nanoscalar particles” are preferably particles with a volume-averaged particle diameter of ≦100 nm. A preferred particle size range is 3 to 50 nm, in particular 4 to 30 nm and particularly preferably 5 to 15 nm. Such particles are distinguished by a high degree of uniformity with respect to their size, size distribution and morphology. The particle size is preferably determined by the UPA method (Ultrafine Particle Analyzer), for example, by the laserlight backscattering method. The nanoscalar ferrite particles used are also superparamagnetic.

The object specified further above is also achieved with a device of the generic type in such a way that a microwave line which is connected to a microwave energy source is arranged in the groove of one of the metal molds.

According to a first preferred embodiment, it is in this case provided that the microwave line is formed as a hollow conductor. This variant is provided with preference whenever the metal molds are not a component part of a metal pressing mold, although this is possible in principle, but instead the metal molds are formed as a kind of master, comprising for example a block of lightweight material (aluminum honeycomb structures, aluminum foam, rigid plastic foam), the upper side of which is formed in such a way that it can receive in a form-fitting manner one of the two molded parts to be joined, on the side opposite from the adhesive joint. In this case, a correspondingly dimensioned groove into which the microwave line is inserted is cut out in one metal mold.

It is most particularly preferred for it to be provided in this case that the metal molds are respectively arranged on a handling device. For this purpose, the metal molds have on the rear side for example a coupling with which they can be coupled to a robot arm. Channels and bores for receiving a permanent magnet or electromagnet, which generate a static magnetic field in the adhesive seam, may be additionally milled into the metal molds. Furthermore, bores for receiving additional holding elements, for example suction cups or mechanical gripper tongs, which fix the respective molded part in the master (metal mold), may be provided. The surface of the metal molds and the inner sides of the milled-in channels are preferably covered with metal sheet or foil in a way that prevents microwaves from passing through and are equipped with supply lines for the microwave energy. For the second molded part to be joined, a correspondingly configured metal mold or master is used in principle, but it is possible to dispense with the microwave components.

Instead of a microwave line formed as a hollow conductor, it is also alternatively possible to provide that the microwave line is formed as a coaxial conductor, which is formed by a wire-like or tubular insulated inner conductor inside the groove and by the groove edge region, which is connected as an outer conductor to the microwave energy source. Such a coaxial conductor is also suitable in the case of the metal molds described above. However, it is particularly suitable for use in a metal pressing mold of a conventional type of construction in which hollow conductors cannot be inserted, since hollow conductors have a minimum cross section which is virtually indistinguishable and in every direction is approximately equal to half the wavelength of the microwave radiation. When using 2.45 GHz radiation, correspondingly a wavelength of 12.2 cm, for example, the hollow conductor must consequently have a cross section of 6×6 cm². The theoretically most favorable inner dimension is a cross-sectional area of 7×3 cm².

In practice, however, often cross sections of only 2×3 cm² are available, so that the hollow conductor technology cannot be used in such ranges. This is possible, however, with the coaxial conductor configuration described above. This type of device can easily be integrated in existing installations or else retrofitted. It is generally not necessary for the pressing mold to be newly fabricated.

In this case, the microwave energy source may be additionally connected to a metal-containing molded part which is arranged between the metal molds on the side facing away from the groove receiving the inner conductor, and together with the inner conductor forms the microwave coaxial conductor.

The connection between the microwave energy source and the coaxial conductor inside the pressing mold takes place by means of at least one connection flange arranged in the region of the groove receiving the inner conductor. The microwave energy can be fed into the groove via this connection flange by means of a conventional RF cable. The microwave energy itself originates, for example, from a magnetron of a commercially available type of construction, which is arranged on the outside of the pressing mold; further connection flanges may be provided for the adjusting measures on the device.

The invention is explained in more detail below by way of example on the basis of the drawing, in which, in each case in a greatly simplified schematic representation:

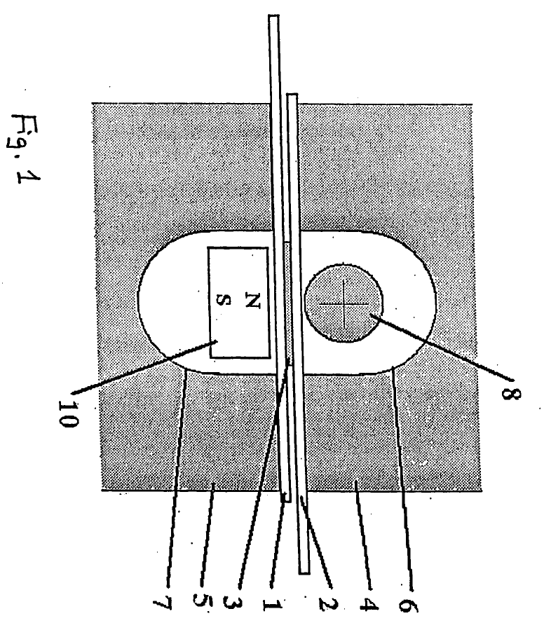

FIG. 1 shows a cross section through a first embodiment of a device according to the invention,

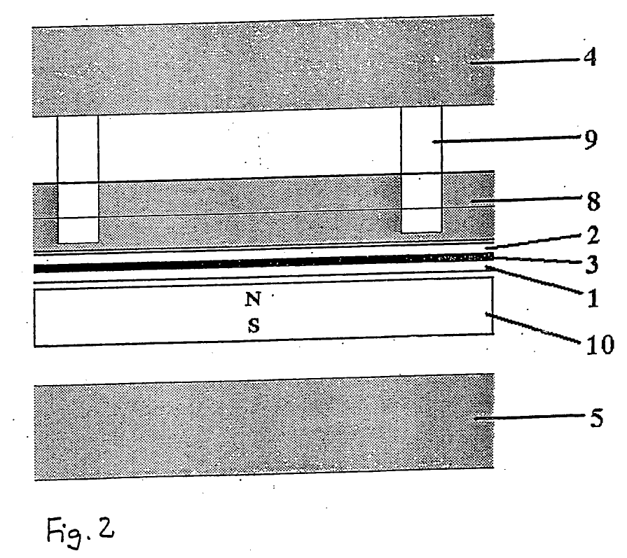

FIG. 2 shows a longitudinal section through the device according to FIG. 1,

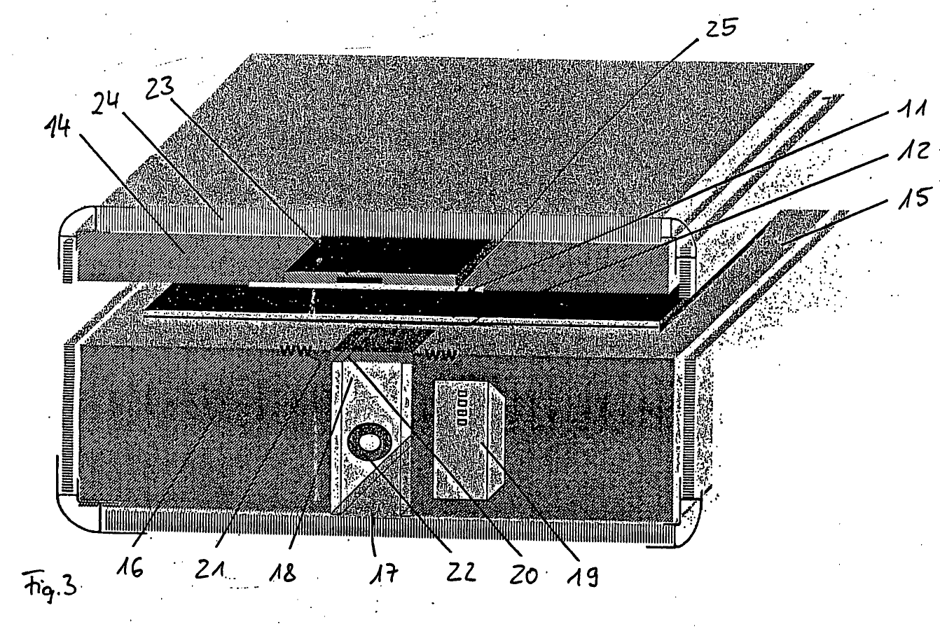

FIG. 3 shows a perspective representation of a second embodiment and

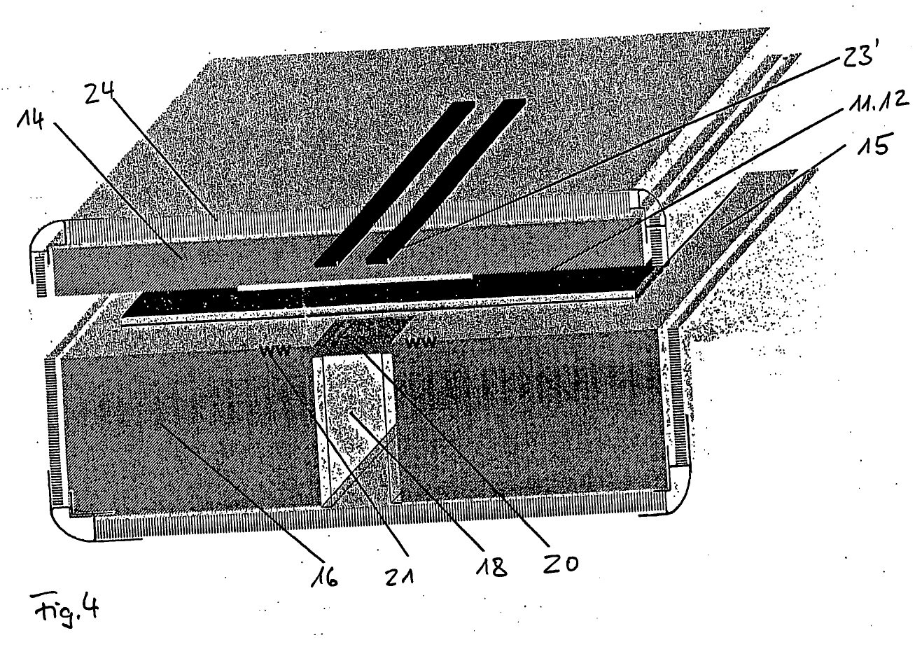

FIG. 4 shows a perspective representation of a third embodiment.

A first configuration of a device according to the invention for connecting molded parts 1, 2 by means of an adhesive seam 3 is formed as a metal pressing mold, which comprises two metal molds for respectively receiving a molded part 1 and 2, that is to say an upper pressing part 4 and a lower pressing part 5. Both parts 4, 5 are made, for example, of diecast aluminum. At least the upper part 4, but preferably also the lower part 5, are respectively provided along the entire adhesive seam 3, parallel to the latter, with a preferably milled groove 6, 7, which is a few cm deep and wide (for example usually 3 cm deep and 2 cm wide). Inserted in the groove 6 along the entire groove 6 is an insulated metal wire 8 or an insulated metal tube, which is held in a fixed position in the groove, for example by means of holding clips 9, to be precise preferably in such a way that the metal conductor 8 is arranged at a distance from the walls of the groove and is in contact with the neighboring molded part 2.

The insulated metal wire 8 forms the inner conductor of a coaxial conductor, the outer conductor of which is formed by the groove edge region of the aluminum pressing mold. The coaxial conductor formed in this way and serving as a microwave line is connected via at least one connection flange (not represented), for example by means of a conventional RF cable, to a microwave energy source (not represented), for example a magnetron of a commercially available type of construction. In the other groove 7, a permanent magnet 10 may be arranged.

When the molded parts 1, 2 to be joined, which are connected by means of an adhesive seam 3, have been placed into the metal pressing mold, and the two pressing mold parts 4 and 5 have been closed, a microwave current is fed in via the electrically insulated inner conductor 8, being passed along the entire adhesive seam 3 by means of this conductor 8. The magnetic lines of flux, which are not represented in the drawing and enclose the inner conductor 8, penetrate through the two represented molded parts 1, 2 of plastic and the microwave-absorbing adhesive seam 3 located inbetween, which is heated by the radiation and sets. Suitable as the microwave source are conventional magnetron transmitters with a frequency of 2.45 GHz and an output of between 800 W and several kW.

The aluminum pressing mold 4, 5 at the same time has the effect of shielding the space outside the device from the microwave radiation.

Such high-frequency magnetic fields (by contrast with RF magnetic fields from induction installations, the frequency of which is only a few MHz) are not capable of penetrating into the aluminum pressing mold, but always run in the microwave channel, i.e., along the inner surface of the groove 6. As a consequence of this, the pressing mold is not heated by the microwave radiation.

Assuming heating of the adhesive seam 3 from 20° C. to 120° C. to be achieved in 30 seconds, the demand for microwave outputs is around 1 kW/m length of the adhesive seam 3.

Polyurethane adhesives (1- or 2-component), which are preferably mixed with 3 to 5% by weight of a dispersion of nanoferrites, for example nanoscalar nickel-zinc ferrite, are usually used as adhesives for the adhesive seam 3. These ferritic additions have the effect of drastically increasing the energy absorption from the high-frequency magnetic field.

The following parameters have been found to be particularly favorable for carrying out the method according to the invention:

Operating frequency of the microwave energy source: 1 MHz to 300 GHz, preferably 500 MHz to 25 GHz, in particular 900 MHz to 6 GHz and ISM frequencies of 915 MHz, 2.45 GHz, 5.8 GHz respectively +/−5%.

Output per meter length of the coaxial conductor: 10 W/m to 50 kW/m, preferably 100 W/m to 5 kW/m.

Outer conductor cross section: 5 mm to 25 cm, inner conductor 0.5 mm to 12 cm; preferably on the outside 7 cm to 9 cm, inner conductor 2 cm to 4 cm.

Optional DC magnetic field: 0 mT to 10 T, preferably 0 mT to 250 mT.

Ferrite additions for the adhesive: magnetic particles of a defined size or particle size distribution of not only metal oxides but also pure metals and metal alloys; preferably ferrites, in particular those of iron, cobalt, nickel, manganese, copper, magnesium, calcium, lithium oxides, ytrium-iron granules (YIG), also those with additions of Ca, Al, In, and/or V.

Particle size of the ferrite: 2 nm to 100 μm, preferably 5 nm to 100 nm.

Saturation magnetization of the magnetic nanopowder: M=20 mT-2.5 T, preferably: 100-500 mT.

FIG. 3 shows another embodiment of a device according to the invention, which does not take the form of a metal pressing mold, but instead has two metal molds 14, 15 for receiving molded parts 11, 12 to be connected by means of an adhesive seam (not represented), which molds can be coupled by means of couplings (not represented) or the like to a handling device, for example a handling arm of a robot, and can be moved independently of one another, in particular can also be pressed together, in order to connect the molded parts 11, 12 to one another.

The lower metal mold 15, as depicted in FIG. 3, has a block of lightweight material 16, which comprises, for example, an aluminum honeycomb structure of aluminum foam or a rigid plastic foam. The upper side is formed in such a way that it can receive in a form-fitting manner one of the two molded parts, that is to say the molded part 12; cut out along the adhesive seam to be produced is a groove 17, which in the case of the exemplary embodiment receives a hollow microwave conductor 18 as a microwave line. Instead of the hollow microwave conductor 18, a coaxial conductor may also be used. A microwave energy source 19, for example a magnetron, is integrated in the block 16; the groove 17 is covered toward the molded part 12, for example by a plastic covering 20. Furthermore, a microwave deflecting profile 21 and a choke plunger 22 are provided.

The upper metal mold 14 may be formed in the same way in principle, with the difference that no microwave line is provided. In the exemplary embodiment represented, the configuration is somewhat different. The upper metal mold 14 receives in a groove a permanent magnet 23, which is located above the adhesive seam to be formed. Furthermore, the metal mold 14 has on the upper side an outer aluminum honeycomb core 24. Toward the molded parts 11, 12, a reflector 25 is arranged.

The working procedure, for example, when adhesively bonding automobile parts, for example, an inner shell and an outer shell of a vehicle door, with this device is as follows: two industrial robots, which carry the metal molds 14 and 15 on their arms use these tools to receive the inner shell and the outer shell of the door. One of the two parts, for example the inner shell, is moved along the later adhesive seam at a stationarily mounted metering nozzle of an adhesive dispenser. The metering nozzle squirts a bead of adhesive (for example, a strip of a thixotropic polymerization adhesive mixed with microwave-absorbing additives, such as nanoferrites) for the later adhesive seam onto the molded part concerned, 11 or 12. After that, the robots put together the inner shell and outer shell of the door by correspondingly joining together the metal molds 14 and 15 and the microwave energy source 19 is activated. The adhesive then begins to heat up and harden. Once the hardening time has elapsed, the microwave energy source 19 is switched off. One of the robots, or the metal mold 14 or 15 fastened to it, decouples itself from the door; the other robot then puts down the finished door; the device is then ready for the next adhesive bonding cycle.

Bores (not represented) for receiving additional holding devices, for example suction cups or mechanical gripper tongs, which fix the respective molded part 11, 12 in the respective metal mold 14, 15, may be provided on both metal molds 14, 15.

FIG. 4 shows a device which is modified slightly in comparison with FIG. 3, not all the parts being represented. However, the same reference numerals as in FIG. 3 are used. The only difference is that, instead of the permanent magnet 19 in the case of the embodiment according to FIG. 3, electromagnets 23′ are used, preferably being activated and deactivated at the same time as the microwave energy source 19.

1. A method for connecting a first molded part and a second molded part, at least one of which is comprised of non-metallic material, by means of at least one adhesive seam comprising an adhesive that can be hardened by heat, said method comprising (a) placing the first molded part and the second molded part, at least in certain regions, between a first metal mold and a second metal mold, with at least the first metal mold or the second metal mold having a groove along the adhesive seam, (b) applying the adhesive seam, (c) pressing together the first metal mold, second metal mold, first molded part and second molded part, and (d) heating the adhesive seam, wherein a microwave line is inserted into the groove and, once the first metal mold, second metal mold, first molded part and second molded part have been pressed together, introducing microwaves into the groove by means of the microwave line in order to heat the adhesive seam by absorption of the microwaves.

2. The method as claimed in claim 1, wherein a hollow conductor is used as the microwave line.

3. The method as claimed in claim 1, wherein at least one of the first molded part or second molded part is gripped by the first metal mold or second metal mold, the first metal mold or second metal mold being arranged on a handling device, and said first molded part or second molded part gripped by the first metal mold or second metal mold is moved along an adhesive discharge, with the first metal mold, second metal mold, first molded part and second molded part being thereafter pressed together.

4. The method as claimed in claim 1, wherein a coaxial conductor which comprises a wire-like or tubular insulated inner conductor is used as the microwave line.

5. The method as claimed in claim 4, wherein pressing mold parts of a metal pressing mold are used as the first metal mold and second metal mold.

6. The method as claimed in claim 4, wherein a metal-containing molded part is additionally used as the outer conductor of the coaxial conductor, said metal-containing molded part being arranged between the first metal mold and second metal mold opposite a molded part comprised of non-metallic material, on the side facing away from the groove receiving the inner insulated conductor.

7. The method as claimed in claim 4, wherein a fluid is introduced through at least one of the wire-like or tubular inner insulated conductor or the groove.

8. The method as claimed in claim 1, wherein a plurality of microwave conductor portions which are separately supplied with microwave energy are inserted over the length of the groove.

9. The method as claimed in claim 1, wherein a DC magnetic field is additionally applied to the adhesive seam during the pressing together of the first metal mold and second metal mold.

10. The method as claimed in claim 9, wherein one of the first metal mold or second metal mold has a groove which contains permanent magnets and which does not contain a microwave line.

11. The method as claimed in claim 1, wherein the adhesive seam is comprised of one or more microwave-absorbing fillers.

12. The method as claimed in claim 1, wherein the adhesive seam is comprised of one or more microwave-absorbing fillers selected from the group consisting of carbon black, ferrites, metal particles, expanded metal salts, and dielectrically absorbing salts.

13. The method as claimed in claim 1, wherein the adhesive seam is comprised of one or more ferrites selected from the group consisting of:
Me^{a}₁₋ₓMe^{b}ₓFe₂O₄ and Li₁₋ₓZn₂ₓFe₅₋ₓO₈, where
Me^{a}=Mn, Co, Ni, Mg, Ca, Cu, Zn, Y, V and/or Co;
Me^{b}=Zn and/or Cd, and
X=0-1.

14. A device for connecting molded parts by means of an adhesive seam containing an adhesive that can be hardened by heat, said device comprising a first metal mold and a second metal mold between which the molded parts can be placed, at least in certain regions, at least one of the first metal mold or second metal mold having a groove along the adhesive seam, said groove containing a microwave line which is connected to a microwave energy source.

15. The device as claimed in claim 14, wherein the microwave line is formed as a hollow conductor.

16. The device as claimed in claim 14, wherein at least one of the first metal mold and second metal mold is arranged on a handling device.

17. The device as claimed in claim 14, wherein the microwave line is formed as a coaxial conductor, which is formed by a wire-like or tubular insulated inner conductor inside the groove and by an edge region of the groove, which is connected as an outer conductor to the microwave energy source.

18. The device as claimed in claim 17, wherein the first metal mold and second metal mold are pressing mold parts of a metal pressing mold.

19. The device as claimed in claim 17, wherein the microwave energy source is additionally connected to a metal-containing molded part which is arranged between the first metal mold and second metal mold on the side facing away from the groove containing the inner conductor, and together with the inner conductor forms the coaxial conductor.

20. The device as claimed in claim 17, wherein the connection between the microwave energy source and the coaxial conductor inside the groove takes place by means of at least one connection flange arranged in the region of the groove containing the inner conductor.
